(19) United States
(12) Patent Application Publication
(10) Pub. No.: US 2018/0111345 A1
(43) Pub. Date: Apr. 26, 2018

(54) SYSTEM AND METHOD FOR DETECTING THE PRESENCE AND/OR MEASURING THE QUANTITY OF LIQUID WITHIN A TIRE

(71) Applicant: Robert L. Barnett, Santa Ana, CA (US)

(72) Inventor: Robert L. Barnett, Santa Ana, CA (US)

(21) Appl. No.: 15/711,952

(22) Filed: Sep. 21, 2017

Related U.S. Application Data
(60) Provisional application No. 62/412,676, filed on Oct. 25, 2016.

(51) Int. Cl. B29C 73/16

(52) U.S. Cl. CPC B29C 73/166; B60C 19/122

(57) ABSTRACT

A system and method for detecting the presence or measuring the quantity of liquid within a tire assembly is disclosed. The system includes an energy source, an energy detector, a controller, and a determination indicator. The energy source is configured to direct energy towards the liquid, with the energy interacting with the liquid. The energy detector is configured to detect at least a portion of the energy after having interacted with the liquid and to generate signals indicative of the detected energy. The controller is configured to receive user input and to control at least one of the energy source and the energy detector in response to the user input. The controller is further configured to receive the signals generated by the energy detector, to respond to the signals by generating a determination regarding the liquid within the tire assembly, and to generate a signal indicative of the determination. The determination indicator is configured to receive the signal indicative of the determination and to provide user output which is indicative of the determination

### CROSS-REFERENCE TO RELATED APPLICATIONS

This application claims the benefit of priority to U.S. Provisional Appl. No. 62/412,676 filed Oct. 25, 2016, which is incorporated in its entirety by reference herein.

### BACKGROUND

### Field

This application relates generally to systems, devices, and methods for detecting the presence and/or measuring the quantity of liquid in an enclosed volume.

### Description of the Related Art

Until recently, bicycle tires have utilized inner tubes within the tire. Presently, tubeless bicycle tires have become common for both mountain bicycles and road bicycles. For a variety of reasons, tubeless bicycle tires are not airtight and often do not form an airtight seal with the bicycle wheel rim. In some circumstances, a small amount (e.g., 2-4 ounces of liquid sealant) can be provided within the tire to seal the interior surface of the tire and the junction between the tire and the rim.

The liquid sealant can be useful to seal small leaks that can occur during riding the bicycle, e.g., leaks created by punctures of the tire caused by thorns, nails, screws, or other sharp objects. Over time, the liquid sealant dries up, reducing or eliminating the possibility of the liquid sealant being able to seal new leaks. To continue providing the ability of sealing new leaks, it is desirable to add additional liquid sealant within the tire to maintain the ability to seal punctures. However, the process of adding additional liquid sealant (e.g., via the valve stem, examples of which may include but are not limited to a Presta valve stem or a Schrader valve stem) can result in pressure loss from within the tire assembly, potentially causing the tire to disengage from a portion of the rim, effectively “popping” the seal between the tire and the rim. In such circumstances, re-engaging the tire with the rim to re-form the seal may require use of a high pressure pneumatic system, which may not be readily available.

In view of the potential for popping the seal, it is desirable to avoid attempting to add additional liquid sealant to the tire when there is still sufficient liquid sealant within the tire. However, it can be difficult to determine if any liquid sealant remains within the tire (and if so, how much). Various systems have previously been disclosed for invasive or direct detection and/or measurement of the liquid sealant within the tire. For example, WO2015/124239 discloses a valve for tubeless tires having a probe extending through the valve stem, and each of U.S. Pat. Nos. 6,722,191 and 8,939,020 discloses a monitor that is designed to roll on the inside of a tire or to float on a liquid inside of a tire.

### SUMMARY

In certain embodiments, a system is provided that is responsive to liquid within a tire assembly. The system comprises an energy source, an energy detector, a controller, and a determination indicator. The energy source is configured to direct energy towards the liquid, with the energy interacting with the liquid. The energy detector is configured to detect at least a portion of the energy after having interacted with the liquid and to generate signals indicative of the detected energy. The controller is configured to receive user input and to control at least one of the energy source and the energy detector in response to the user input. The controller is further configured to receive the signals generated by the energy detector, to respond to the signals by generating a determination regarding the liquid within the tire assembly, and to generate a signal indicative of the determination. The determination indicator is configured to receive the signal indicative of the determination and to provide user output which is indicative of the determination.

In certain embodiments, a method is provided for detecting the presence or measuring the amount of a liquid within a tire assembly. The method comprises directing energy towards the liquid, the energy interacting with the liquid. The method further comprises detecting at least a portion of the energy after having interacted with the liquid. The method further comprises controlling, in response to user input, at least one of said directing energy and said detecting at least a portion of the energy. The method further comprises generating a determination regarding the liquid within the tire assembly. The method further comprises providing user output which is indicative of the determination.

### BRIEF DESCRIPTION OF THE DRAWINGS

FIGS. 1A and 1B schematically illustrate an example system responsive to liquid within a tire assembly in accordance with certain embodiments described herein.

FIG. 2 schematically illustrates another example system responsive to liquid within a tire assembly in accordance with certain embodiments described herein.

FIG. 3 schematically illustrates another example system responsive to liquid within a tire assembly in accordance with certain embodiments described herein.

FIG. 4 is a flow diagram of an example method for detecting the presence or measuring the amount of a liquid within a tire assembly in accordance with certain embodiments described herein.

### DETAILED DESCRIPTION

Certain embodiments described herein provide a system, method, and device for noninvasive detection and/or measurement of a liquid sealant within a tire assembly comprising a tire mounted to a rim. In certain such embodiments, energy is directed towards the liquid sealant within the tire and interacts with the liquid sealant, and at least a portion of the energy is detected after having interacted with the liquid sealant. Based at least in part on the detected energy, a determination is made regarding the existence of the liquid sealant and/or the amount of liquid sealant within the tire.

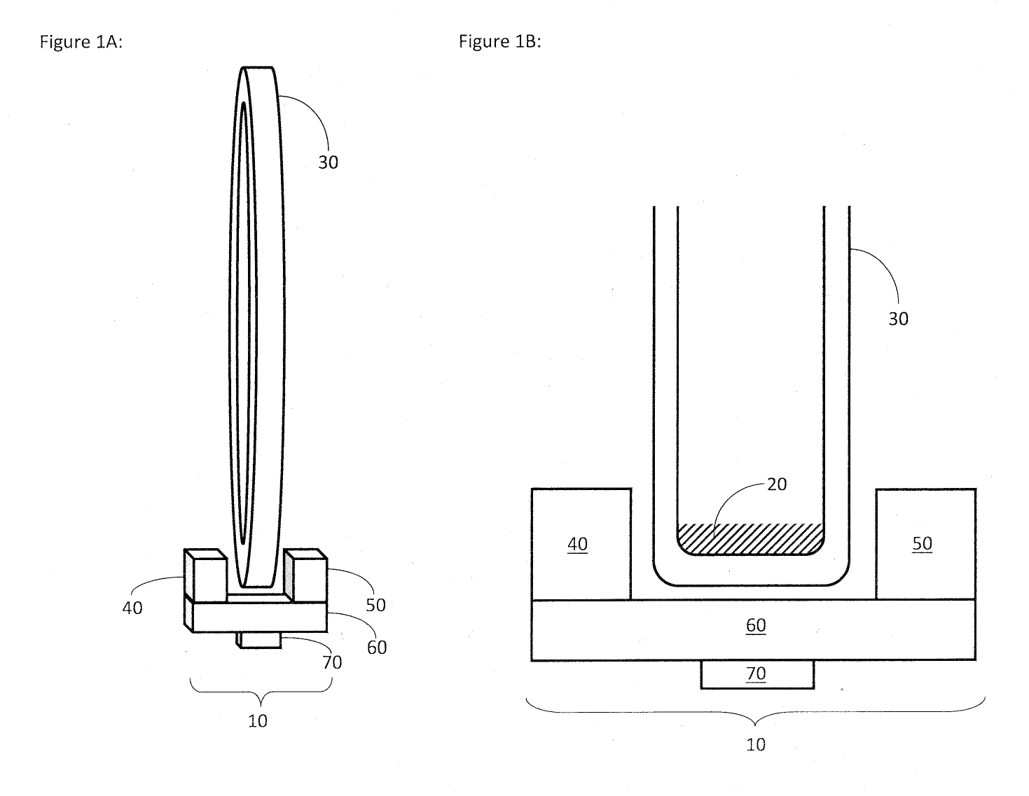

FIGS. 1A and 1B (not to scale) schematically illustrate an example system 10 responsive to liquid 20 within a tire assembly 30 in accordance with certain embodiments described herein. The system 10 comprises an energy source 40, an energy detector 50, a controller 60, and a determination indicator 70. The energy source 40 is configured to direct energy towards the liquid 20, with the energy interacting with the liquid 20. The energy detector 50 is configured to detect at least a portion of the energy after having interacted with the liquid 20 and to generate signals indicative of the detected energy. The controller 60 is configured to receive user input and to control at least one of the energy source 40 and the energy detector 50 in response to the user input. The controller 60 is further configured to receive the signals generated by the energy detector 50, to respond to the signals by generating a determination regarding the liquid 20 within the tire assembly 30 (e.g., regarding the existence of the liquid 20 within the tire assembly 30 and/or the amount of liquid 20 within the tire assembly 30), and to generate a signal indicative of the determination. The determination indicator 70 is configured to receive the signal indicative of the determination (e.g., from the controller 60) and to provide user output which is indicative of the determination.

In certain embodiments, the liquid 20 comprises a liquid sealant. The liquid sealant can comprise a suspension of particles, flakes, and/or fine fibers in a liquid or a natural or synthetic liquid rubber (e.g., latex). Examples of liquid sealants compatible with certain embodiments described herein include but are not limited to: TIRE LIFE® Tire Sealant sold by Fuller Bros. of Clackamas, Oreg.; Slime® Original Formula Sealant sold by ITW Global Tire Repair, Inc. of San Luis Obispo, Calif.; Stan's No Tubes™ Tire Sealant sold by Stan's No Tubes of Big Flats, N.Y.; Caffelatex Tire Sealant sold by Effetto Mariposa of Cantone Ticino, Switzerland.

In certain embodiments, the tire assembly 30 comprises a tire and a rim, with the tire mounted to the rim. The tire can comprise a tubeless bicycle tire or other types of tires (e.g., other configurations of tires; tires used with other wheeled transportation devices, such as automobiles, trucks, scooters, motorcycles, etc.). The tire can comprise rubber and the rim can comprise metal (e.g., aluminum; steel).

In certain embodiments, the system 10 (e.g., comprising the energy source 40, the energy detector 50, the controller 60, and the determination indicator 70) is sized to be handheld by the user (e.g., at least a portion of the system 10 is configured to fit within the user's hand; generally the size of a smartphone) so that the user can position the system 10 in relation to the tire assembly 30 for operation of the system 10. In certain other embodiments, the system 10 is configured to be placed on the floor or in another position so that the tire assembly 30 can be positioned (e.g., either while mounted to the bicycle or while dismounted from the bicycle) in relation to the system 10 for operation of the system 10.

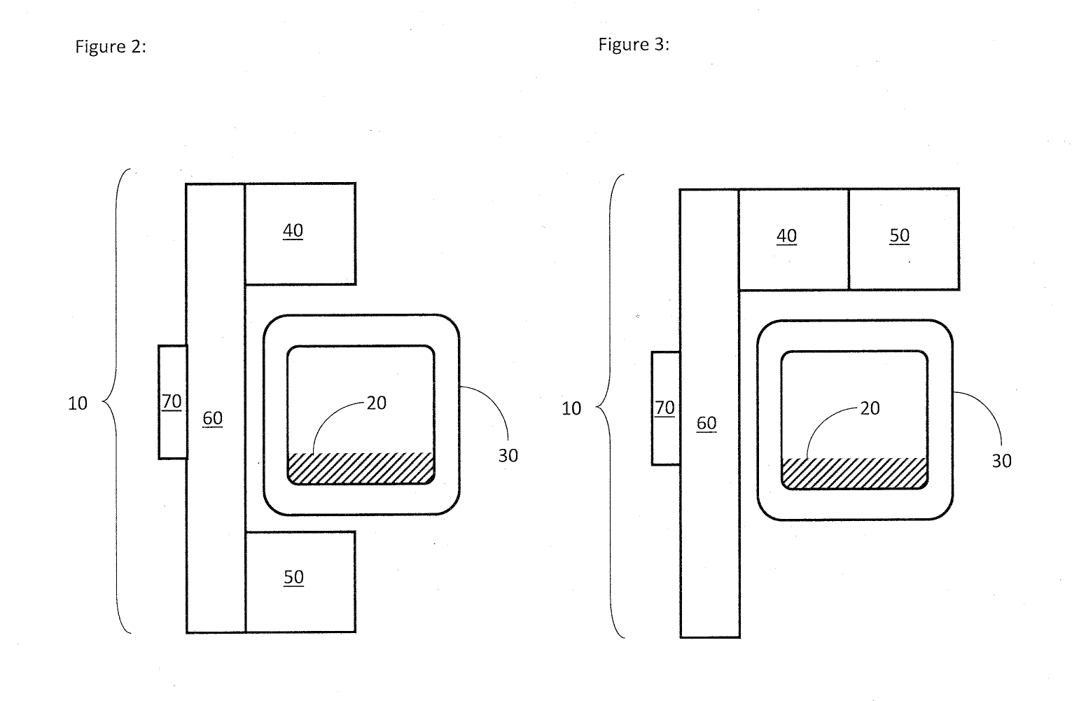

At least one of the energy source 40 and the energy detector 50 can be positioned to be in contact with the tire assembly 30 during operation, while in certain other embodiments, at least one of the energy source 40 and the energy detector 50 is positioned to be spaced from the tire assembly 30 during operation. In certain embodiments, the system 10 is configured to have the energy source 40 and the energy detector 50 at opposite sides of the tire assembly 30 (e.g., and of the liquid 20 within) during operation of the system 10, with the tire assembly 30 (e.g., and the liquid 20 within) positioned along a line extending from the energy source 40 to the energy detector 50. For example, as schematically shown in FIGS. 1A and 1B, the liquid 20 within the tire assembly 30 is between the energy source 40 and the energy detector 50, with one of the energy source 40 and the energy detector 50 at a first side (e.g., the left side) of the liquid 20 and the other of the energy source 40 and the energy detector 50 at a second side (e.g., the right side) of the liquid 20. In certain such embodiments, at least some of the energy from the energy source 40 propagates across a width of the liquid 20 within the tire assembly 30 and is received by the energy detector 50. FIG. 2 (not to scale) schematically illustrates another example system 10 in accordance with certain embodiments described herein with one of the energy source 40 and the energy detector 50 above the liquid 20 and the other of the energy source 40 and the energy detector 50 below the liquid 20. In certain such embodiments, at least some of the energy from the energy source 40 propagates through a depth of the liquid 20 within the tire assembly 30 and is received by the energy detector 50. The system 10 can have a general U-shape which fits around the tire assembly 30 with the energy source 40 and the energy detector 50 positioned in different arms of the U-shape (see, e.g., FIGS. 1A, 1B, and 2). Certain such embodiments can be used in configurations in which the energy detector 50 is configured to detect at least some of the energy transmitted through the liquid 20.

In certain other embodiments, the system 10 is configured to have the energy source 40 and the energy detector 50 at the same side of the tire assembly 30 (e.g., and the liquid 20 within) as one another. For example, FIG. 3 (not to scale) schematically illustrates another example system 10 in accordance with certain embodiments described herein with the energy source 40 and the energy detector 50 both at the same side of the liquid 20 (e.g., both above the liquid 20) or the energy source 40 and the energy detector 50 can be at different sides (e.g., at an angle from one another; 90 degrees from one another). In certain such embodiments, at least some of the energy from the energy source 40 is reflected by at least a portion of the liquid 20 within the tire assembly 30 and is received by the energy detector 40. Certain such embodiments can be used in configurations in which the energy detector 50 is configured to detect energy reflected from the liquid 20.

In certain embodiments, the energy emitted by the energy source 40 is configured to be transmitted through the tire assembly 30 (e.g., transmitted through the tire, through the rim, or both), to interact with the liquid 20 within the tire assembly 30, and to be transmitted again through the tire assembly 30 (e.g., transmitted through the tire, through the rim, or both). Examples of types of energy compatible with certain embodiments described herein include but are not limited to: electromagnetic waves; infrared radiation; radio waves; microwaves; x-rays; gamma rays; magnetic energy or magnetic fields; electrical energy or electrical fields; acoustic waves; sound waves; low frequency vibrations; high-frequency vibrations; ultrasonic waves; combinations of two or more of these types of energy. The energy has one or more attributes (e.g., magnitude; intensity; spectral distribution; frequency; range of frequencies; polarity; propagation direction) that is changed (e.g., affected; modified) by the energy interacting with the liquid 20. The amount of change of the one or more attributes can be indicative of the existence of liquid 20 within the tire assembly 30 or indicative of the amount of liquid 20 within the tire assembly 30. The change of the one or more attributes due to the energy interacting with the liquid 20 is different (e.g., in magnitude; in polarity; in direction) from any change of the one or more attributes due to the energy interacting with the tire assembly 30 or the surroundings. Thus, the existence of a detected change and/or an amount of a detected change can be indicative of the existence and/or the amount of liquid 20 within the tire assembly 30. The change of the one or more attributes can be caused by one or more properties of the liquid 20, including but not limited to the liquid's mass, liquid level within the tire assembly 30, chemical composition, nuclear isotopic composition, response to electrical stimulation, response to magnetic stimulation, response to acoustic stimulation. The one or more properties of the liquid 20 can be inherent in a sealant portion of the liquid 20 or can be a property of an additive (e.g., magnetic particles) combined with a sealant portion of the liquid 20 prior to introduction of the liquid 20 into the tire assembly 30 for the purpose of providing a property (e.g., response to magnetic stimulation) to cause a suitable change of an attribute of the energy (e.g., magnetic energy or magnetic field).

The energy detector 50 of certain embodiments detects at least a portion of the energy which is transmitted through the tire assembly 30 (e.g., through the tire, through the rim, or both) after having interacted with the liquid 20 within the tire assembly 30. In certain embodiments in which an attribute of the energy detected by the energy detector 50 is dependent upon the existence and/or amount of the liquid 20 within the tire assembly 30, the energy detector 50 can be configured to generate signals indicative of the attribute of the energy detected by the energy detector 50. For example, in certain embodiments in which the amount of energy detected by the energy detector 50 is dependent upon the existence and/or amount of the liquid 20 within the tire assembly 30, the energy detector 50 can be configured to generate signals indicative of the existence and/or the amount of energy detected by the energy detector 50. For another example, in certain embodiments in which the spectral distribution (e.g., frequency; range of frequencies) of the energy detected by the energy detector 50 is dependent upon the existence and/or the amount of the liquid 20 within the tire assembly 30, the energy detector 50 can be configured to generate signals indicative of the spectral distribution of the energy detected by the energy detector 50.

In certain embodiments, the controller 60 (e.g., one or more processor circuits; one or more microprocessors; one or more integrated circuits) is configured to receive user input and to control the energy source 40 and/or the energy detector 50 in response to the user input. The user input can be provided by one or more actuators (e.g., buttons; switches; keyboards; touchscreens; touchpads; trackballs) of the system 10 that are configured to allow the user to input parameters and/or commands to the controller 60. For example, the system 10 may be turned off/on by a power switch and the controller 60 can begin operation of the system 10 upon being turned on. For another example, more complicated user input (e.g., mode of operation; parameters of operation; form of output) may be received by the controller 60 by the user moving a cursor on a display screen in communication with the controller 60. The controller 60 can be configured to respond to the user input by generating and transmitting control signals to the energy source 40 and/or the energy detector 50, and the energy source 40 and/or the energy detector 50 can be responsive to these control signals by operating in accordance with the user input.

In certain embodiments, the controller 60 is further configured to receive the signals generated by the energy detector 50 which are indicative of one or more attributes (e.g., amount; spectral distribution) of the portion of the energy detected by the energy detector 50, to respond to the signals from the energy detector 50 by generating a determination regarding the existence of the liquid 20 and/or the amount of liquid 20 within the tire assembly 30, and to generate a signal indicative of the determination. The determination indicator 70 is configured to receive the signal indicative of the determination from the controller 60 and to provide user output which is indicative of the determination. The determination indicator 70 can comprise one or more visual display elements (e.g., lights; LEDs; display screen regions) and/or one or more auditory elements (e.g., speakers; buzzers) which are configured to communicate the determination to the user. For example, the determination indicator 70 can comprise a buzzer which generates a sound that is indicative of the existence/non-existence of sufficient liquid 20 within the tire assembly 30 and/or an amount of liquid 20 within the tire assembly 30. For another example, the determination indicator 70 can comprise one or more LEDs which generate visible light indicative of the existence/non-existence of sufficient liquid 20 within the tire assembly 30 and/or an amount of liquid 20 within the tire assembly 30. For another example, the determination indicator 70 can comprise multiple lights (e.g., LEDs) arranged in a line with one another, and the controller 60 can turn on a series of lights adjacent to one another, the length of the lit series of lights indicative of the detected depth of the liquid 20 within the tire assembly 30. For still another example, the determination indicator 70 can comprise a display screen (e.g., an LCD display screen) having a region which shows a graphical representation (e.g., a line showing a density profile across a portion of the tire assembly 30; a grey strip having a length indicative of a depth level of the liquid 20 within the tire assembly 30) indicative of the existence/non-existence of sufficient liquid 20 within the tire assembly 30 and/or an amount of liquid 20 within the tire assembly 30.

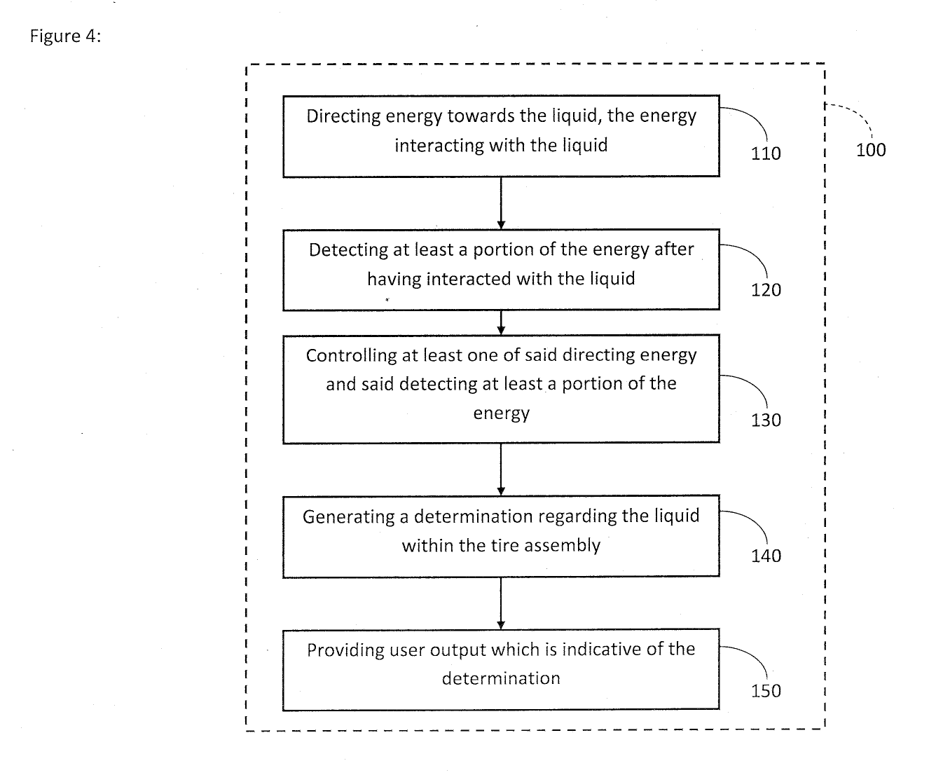

FIG. 4 is a flow diagram of an example method 100 for detecting the presence or measuring the amount of a liquid within a tire assembly in accordance with certain embodiments described herein. In an operational block 110, the method 100 comprises directing energy towards the liquid, the energy interacting with the liquid. In an operational block 120, the method 100 further comprises detecting at least a portion of the energy after having interacted with the liquid. In an operational block 130, the method 100 further comprises controlling, in response to user input, at least one of said directing energy and said detecting at least a portion of the energy. In an operational block 140, the method 100 further comprises generating a determination regarding the liquid within the tire assembly. In an operational block 150, the method 100 further comprises providing user output which is indicative of the determination. In certain embodiments, the method 100 can be performed using a system 10 as described herein, while in certain other embodiments, the method 100 can be performed using other systems and devices.

### Example Using Acoustic Waves

In an example embodiment in which the energy comprises acoustic waves (e.g., vibrations, sound waves, or ultrasonic waves), the energy source 40 can comprise one or more piezoelectric elements, speaker membranes, or other elements which vibrate in response to an electrical signal. The energy detector 50 can comprise one or more piezoelectric elements, microphone membranes, or other elements which vibrate in response to the detected acoustic waves and generate signals indicative of the one or more attributes of the acoustic waves which interact with the liquid 20.

In certain embodiments, the energy source 40 can be positioned to be in contact with a wall of the tire assembly 30 (e.g., a wall of the tire; a wall of the rim) during operation, so that the acoustic waves are imparted directly to the wall of the tire assembly 30. In certain other embodiments, the energy source 40 is positioned to be spaced from the wall of the tire assembly 30 during operation, so that the acoustic waves are imparted to the air gap between the energy source 40 and the tire assembly 30 and propagate across the air gap to impinge the wall of the tire assembly 30.

The acoustic waves propagate from the wall of the tire assembly 30 towards the liquid 20. In certain embodiments, the acoustic waves are imparted directly by the wall of the tire assembly 30 to the liquid 20 within the tire assembly 30, while in certain other embodiments, the acoustic waves are imparted to an air gap between the wall of the tire assembly 30 and propagate across the air gap to impinge the liquid 20. The acoustic waves that impinge the liquid 20 have one or more attributes (e.g., intensity; frequency; range of frequencies) that are affected by interaction of the acoustic waves with the liquid 20.

A portion of the acoustic waves which interacts with the liquid 20 can propagate from the liquid 20 to the energy detector 50. For example, the portion of the acoustic waves can propagate from the liquid 20 to a wall of the tire assembly 30 (e.g., the same wall from which the incident acoustic waves propagated or a different wall of the tire assembly 30) either directly or through an air gap between the liquid 20 and the wall, and from the wall to the energy detector 50 (e.g., either directly when the energy detector 50 is in contact with the wall of the tire assembly 30 or by propagating through an air gap between the wall and the energy detector 50 when the energy detector 50 is spaced from the wall of the tire assembly 30).

Based on the one or more attributes of the detected acoustic waves, the energy detector 50 can generate and transmit signals to the controller 60. The controller 60 can analyze these signals and generate a determination of the amount and/or existence/non-existence of the liquid 20 within the tire assembly 30, and can generate and transmit appropriate signals to the determination indicator 70 to inform the user of the determination.

Although certain embodiments and examples are discussed above, it is understood that the inventive subject matter extends beyond the specifically disclosed embodiments to other alternative embodiments and/or uses of the invention and obvious modifications and equivalents thereof. It is intended that the scope of the inventions disclosed herein should not be limited by the particular disclosed embodiments. Thus, for example, in any method or process disclosed herein, the acts or operations making up the method/process may be performed in any suitable sequence and are not necessarily limited to any particular disclosed sequence. Features or elements from various embodiments and examples discussed above may be combined with one another to produce alternative configurations compatible with embodiments disclosed herein. Various aspects and advantages of the embodiments have been described where appropriate. It is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

What is claimed is:

1. A system for detecting the presence or measuring the amount of a liquid sealant within a tire, the system comprising:
a source of acoustic waves configured to direct the acoustic waves towards the liquid sealant, the acoustic waves interacting with the liquid sealant;
a detector of acoustic waves configured to detect at least a portion of the acoustic waves after having interacted with the liquid sealant and to generate signals indicative of the detected acoustic waves;
a controller configured to receive user input and to control at least one of the source and the detector in response to the user input, the controller further configured to receive the signals generated by the detector, to respond to the signals by generating a determination regarding the liquid sealant within the tire, and to generate a signal indicative of the determination; and
a determination indicator configured to receive the signal indicative of the determination and to provide user output which is indicative of the determination.

2. A system responsive to liquid within a tire assembly, the system comprising:
an energy source configured to direct energy towards the liquid, the energy interacting with the liquid;
an energy detector configured to detect at least a portion of the energy after having interacted with the liquid and to generate signals indicative of the detected energy;
a controller configured to receive user input and to control at least one of the energy source and the energy detector in response to the user input, the controller further configured to receive the signals generated by the energy detector, to respond to the signals by generating a determination regarding the liquid within the tire assembly, and to generate a signal indicative of the determination; and
a determination indicator configured to receive the signal indicative of the determination and to provide user output which is indicative of the determination.

3. The system of claim 2, wherein the liquid comprises a liquid sealant and the tire assembly comprises a tire comprising rubber and a rim comprising metal, with the tire mounted to the rim.

4. The system of claim 2, wherein at least one of the energy source and the energy detector is configured to be in contact with the tire assembly during operation of the system.

5. The system of claim 2, wherein at least one of the energy source and the energy detector is configured to be spaced from the tire assembly during operation of the system.

6. The system of claim 2, wherein, during operation of the system, the energy source and the energy detector are positioned at opposite sides of the liquid from one another, with the tire assembly positioned along a line extending from the energy source to the energy detector, such that the liquid is between the energy source and the energy detector.

7. The system of claim 6, wherein, during operation of the system, at least some of the energy from the energy source propagates into the tire assembly, across a width of the liquid, out of the tire assembly, and is received by the energy detector.

8. The system of claim 6, wherein, during operation of the system, one of the energy source and the energy detector is positioned above the liquid and the other of the energy source and the energy detector is positioned below the liquid.

9. The system of claim 6, wherein, during operation of the system, at least some of the energy from the energy source propagates into the tire assembly, through a depth of the liquid, out of the tire assembly, and is received by the energy detector.

10. The system of claim 2, wherein, during operation of the system, at least some of the energy from the energy source propagates into the tire assembly, is reflected by at least a portion of the liquid, propagates out of the tire assembly, and is received by the energy detector.

11. The system of claim 10, wherein, during operation of the system, the energy source and the energy detector are positioned at the same side of the liquid as one another.

12. The system of claim 2, wherein the energy emitted by the energy source comprises one or more of: electromagnetic waves, infrared radiation, radio waves, microwaves, x-rays, gamma rays, magnetic energy or magnetic fields, electrical energy or electrical fields, acoustic waves, sound waves, low frequency vibrations, high-frequency vibrations, and ultrasonic waves.

13. The system of claim 2, wherein the energy emitted by the energy source has at least one attribute comprising one or more of: magnitude, intensity, spectral distribution, frequency, range of frequencies, polarity, and propagation direction, wherein the at least one attribute is affected by interaction of the energy with the liquid, such that the at least one attribute is indicative of the existence of liquid within the tire assembly or indicative of the amount of liquid within the tire assembly.

14. The system of claim 2, wherein the energy comprises acoustic waves, the energy source comprises one or more elements which vibrate in response to an electrical signal, and the energy detector comprises one or more elements which vibrate in response to the detected energy and generate signals indicative of the energy which interacts with the liquid.

15. A method for detecting the presence or measuring the amount of a liquid within a tire assembly, the method comprising:
directing energy towards the liquid, the energy interacting with the liquid;
detecting at least a portion of the energy after having interacted with the liquid;
controlling, in response to user input, at least one of said directing energy and said detecting at least a portion of the energy;
generating a determination regarding the liquid within the tire assembly; and
providing user output which is indicative of the determination.

16. The method of claim 15, wherein said directing energy towards the liquid comprises propagating at least some of the energy into the tire assembly, across a width of the liquid, and out of the tire assembly, and said detecting at least a portion of the energy comprises receiving the at least a portion of the energy from the tire assembly.

17. The method of claim 15, wherein said directing energy towards the liquid comprises propagating at least some of the energy into the tire assembly, through a depth of the liquid, and out of the tire assembly, and said detecting at least a portion of the energy comprises receiving the at least a portion of the energy from the tire assembly.

18. The method of claim 15, wherein said directing energy towards the liquid comprises propagating at least some of the energy into the tire assembly, reflecting the at least some of the energy from at least a portion of the liquid, and propagating the reflected energy out of the tire assembly, and said detecting at least a portion of the energy comprises receiving the at least a portion of the energy from the tire assembly.

19. The method of claim 15, wherein the energy comprises one or more of: electromagnetic waves, infrared radiation, radio waves, microwaves, x-rays, gamma rays, magnetic energy or magnetic fields, electrical energy or electrical fields, acoustic waves, sound waves, low frequency vibrations, high-frequency vibrations, and ultrasonic waves.

20. The method of claim 15, wherein the energy has at least one attribute comprising one or more of: magnitude, intensity, spectral distribution, frequency, range of frequencies, polarity, and propagation direction, wherein the at least one attribute is affected by interaction of the energy with the liquid sealant, such that the at least one attribute is indicative of the existence of liquid within the tire assembly or indicative of the amount of liquid sealant within the tire assembly.

21. The method of claim 15, wherein the liquid comprises a liquid sealant.
